(19) United States
(12) Patent Application Publication
(10) Pub. No.: US 2004/0235489 A1
(43) Pub. Date: Nov. 25, 2004

(54) Apparatus and method for communicating through wireless network

(75) Inventor: Chang-yeul Kwon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/851,094

(22) Filed: May 24, 2004

(30) Foreign Application Priority Data
May 23, 2003 (KR) 2003-33126

(51) Int. Cl. H04M 3/00

(52) U.S. Cl. 455/452.2

(57) ABSTRACT

A method and apparatus for communicating through a wireless network including (a) examining quality of service (QoS) of a current channel; and (b) if it is determined that the QoS of the current channel is below a predetermined standard, receiving data from a device connected to the wireless network and transmitting the data to another device connected to the wireless network. Accordingly, when channel quality is poor, higher QoS can be guaranteed until a new channel is established.

This application claims priority from Korean Patent Application No. 2003-33126, filed on May 23, 2003, in the Korean Intellectual Property Office, the disclosure of which is incorporated herein in its entirety by reference.

### BACKGROUND OF THE INVENTION

1. Field of the Invention

The present invention relates to local area network communication, and more particularly, to a method and apparatus for communicating through a wireless local area network.

2. Description of the Related Art

Various standards are defined for data communication using a wireless local area network (WLAN). For example, the Institute of Electrical and Electronics Engineers (IEEE) standard 802.11 relates to a WLAN, IEEE standard 802.15.3 relates to a wireless personal area network (WPAN), and IEEE standard 802.15.1 relates to the so-called Bluetooth technology.

Specifically, a network in the IEEE standard 802.15.3 is called a piconet. A piconet is controlled by a network controller called a piconet coordinator. The piconet coordinator makes peer-to-peer communication possible by assigning a timeslot to each device that requests data communication. While the data communication is performed, the piconet coordinator occasionally examines channel quality, and if it is determined that the channel quality drops below a predetermined value, the piconet coordinator changes an existing channel to a new channel. In a conventional piconet, a piconet coordinator transmits a beacon for channel synchronization to each device connected to the piconet at a predetermined time interval. Before the piconet coordinator changes a channel, the piconet coordinator sets a countdown using the beacon. According to the value of the countdown, after several beacons are transmitted, the channel is changed. That is, during time required for moving to a new channel, even if the quality of an existing channel is poor, each device must communicate using the existing channel. Therefore, the quality of the existing channel cannot be guaranteed for an extended period of time.

If quality of an existing channel is poor and a new channel to be changed to cannot be found, power for data communication may be increased. However, if the power is increased, a cost of usage is also higher.

### SUMMARY OF THE INVENTION

The present invention provides a method and apparatus for communicating through a wireless local area network. The apparatus changes a channel to guarantee high channel quality without increasing costs.

According to an aspect of the present invention, there is provided a method of communicating through a wireless network, the method comprising: (a) examining quality of service (QoS) of a current channel; and (b) if it is determined that the QoS of the current channel is below a predetermined standard, receiving data from a device connected to the wireless network and transmitting the data to another device connected to the wireless network.

It is further preferable that step (b) comprises: (b1) informing devices connected to the wireless network that the QoS of the current channel is below the predetermined standard; (b2) receiving a relay request from a sending device; (b3) transmitting a relay response to the sending device in response to the relay request; and (b4) receiving data from the sending device and transmitting the data to a receiving device.

It is preferable that step (b) is performed during a predetermined time required for moving to another channel.

It is further preferable that, in step (b), the data is received or transmitted using a timeslot obtained by time-sharing a channel linking the wireless network.

According to another aspect of the present invention, there is provided a method of communicating through a wireless network, the method comprising: (a) examining quality of service (QoS) of a current channel; (b) if it is determined that the QoS of the current channel is below a predetermined standard as a result of the examination, transmitting a beacon including information indicating that the QoS of the current channel is below the predetermined standard to devices connected to the wireless network; (c) receiving a relay request included in the beacon from a sending device; (d) transmitting the beacon including a relay response to the sending device in response to the relay request; and (e) receiving data from the sending device and transmitting the data to a receiving device.

It is preferable that steps (b) through (e) are performed using a timeslot obtained by time-sharing the channel.

It is also preferable that steps (c) and (d) are performed using a medium access control (MAC) header of the beacon.

It is also preferable that steps (c) and (d) are performed using at least one superframe obtained by time-sharing the channel.

It is also preferable that steps (c) and (d) are performed using a timeslot of a superframe obtained by time-sharing the channel.

It is also preferable that step (e) is performed until a predetermined time elapses.

According to another aspect of the present invention, there is provided an apparatus connected to a wireless network, the apparatus comprising: an examiner, which examines quality of service (QoS) of a current channel; and a relay unit, which, if it is determined that the QoS of the current channel is below a predetermined standard as a result of the examination by the examiner, receives data from a sending device connected to the wireless network and transmits the data to a receiving device connected to the wireless network.

It is preferable that the relay unit receives data from the sending device and transmits the data to the receiving device during a predetermined time required for moving to another channel.

It is also preferable that the relay unit informs devices connected to the wireless network when the QoS of the current channel is below the predetermined standard, receives a relay request from the sending device, transmits a relay response to the sending device in response to the relay request, receives data from the sending device, and transmits the data to the receiving device.

It is also preferable that the relay unit receives or transmits the data using a timeslot obtained by time-sharing a channel linking the wireless network.

According to another aspect of the present invention, there is provided an apparatus connected to a wireless network, the apparatus comprising: an examiner, which examines quality of service (QoS) of a current channel; and a relay unit, which, if it is determined that the QoS of the current channel is below a predetermined standard as a result of the examination by the examiner, transmits a beacon including information indicating that the QoS of the current channel is below the predetermined standard to devices connected to the wireless network, receives a relay request included in the beacon from a sending device, transmits the beacon including a relay response to the sending device in response to the relay request, receives data from the sending device, and transmits the data to a receiving device.

It is further preferable that the relay unit receives or transmits the data using a timeslot obtained by time-sharing a channel linking the wireless network.

It is further preferable that the relay unit transmits the beacon with a medium access control (MAC) header including the relay request and the relay response.

It is further preferable that the relay unit communicates with the device using at least one superframe obtained by time-sharing the channel.

It is further preferable that the relay unit communicates with the device using a timeslot of a superframe obtained by time-sharing the channel.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a piconet according to an exemplary embodiment of the present invention;

FIG. 2 is a block diagram of a piconet coordinator according to an exemplary embodiment of the present invention;

FIG. 3 illustrates a format of a superframe forming a channel of the piconet;

FIG. 4 illustrates a format of a MAC frame in which a request and a response for relay communication are included, according to an exemplary embodiment of the present invention;

FIG. 5 illustrates a command format for requesting relay communication according to an exemplary embodiment of the present invention;

FIG. 6 illustrates a command format for responding to relay communication according to an exemplary embodiment of the present invention; and

FIG. 7 illustrates a communication method according to an exemplary embodiment of the present invention.

### DETAILED DESCRIPTION OF THE INVENTION

The present invention will now be described more fully with reference to the accompanying drawings, in which exemplary embodiments of the invention are shown.

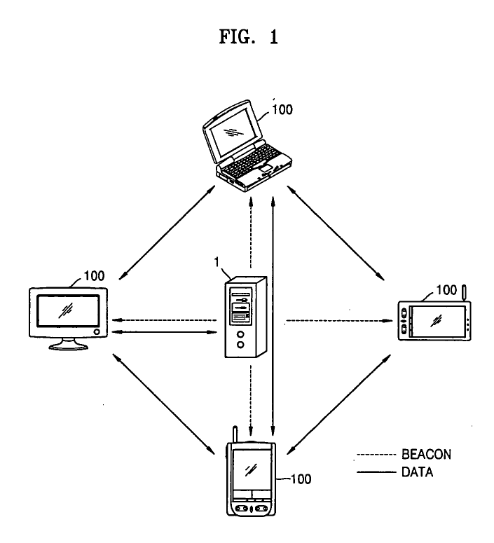

FIG. 1 is a schematic diagram of a piconet according to an exemplary embodiment of the present invention.

Referring to FIG. 1, a piconet is a wireless ad hoc data communication system enabling a plurality of independent devices to perform data communication with each other and includes a plurality of devices such as devices 1 and 100. The devices 1 and 100, which are portable, movable, and can be used by personal users, include cellphone handsets, laptop computers, personal digital assistances (PDAs), desktop computers, etc. The piconet has a single channel for data communication. That is, devices connected to the piconet perform peer-to-peer communication using superframes obtained by time-sharing one channel. A piconet coordinator 1 provides global timing reference for synchronization to each of the devices 100 using a beacon. The piconet coordinator 1 examines channel quality, and if the channel quality is determined to be lower than a certain standard, that is, if it is determined that quality of service (QoS) cannot be guaranteed because the channel quality is poor, the piconet coordinator 1 performs relay communication instead of peer-to-peer communication between a sending device and a receiving device during a predetermined time required for changing to a new channel.

FIG. 2 is a block diagram of the piconet coordinator 1 according to an exemplary embodiment of the present invention.

Referring to FIG. 2, the piconet coordinator 1 includes an examiner 11 and a relay unit 12. The examiner 11 examines QoS of a channel. Various examining methods can be used. For example, throughput of the channel or an error rate of the channel can be examined. If the QoS of a current channel is determined to be below a predetermined standard by the examiner 11, the relay unit 12 performs relay communication, receiving data from a device 100 connected to the piconet and transmitting the data to another device 100.

FIG. 3 illustrates a format of superframes forming a channel of the piconet.

Referring to FIG. 3, a channel includes a plurality of consecutive superframes. A superframe is a time slot forming a channel on a time axis. A superframe #m includes a plurality of timeslots such as a beacon #m, a contention access period (CAP), and a contention free period (CFP), each of which includes a plurality of smaller sized timeslots. The beacon #m provides a global timing reference and is used to exchange information for communication management of the piconet. Accordingly, the beacon #m includes time slots for parameters for synchronization of the piconet and time slots for a plurality of information elements. Each device 100 and the piconet coordinator 1 can use the timeslots for the information elements to exchange mutually necessary information. The CAP is used to exchange commands or transmit asynchronous data. The CAP is optional. The CFP includes a plurality of management channel time allocations (MCTAs) and a plurality of channel time allocations (CTAs). The CTAs are used to exchange commands or transmit isochronous streams or asynchronous data.

According to the present invention, information exchange for a relay request and a relay response between the piconet coordinator 1 and a device 100 is performed using a predetermined timeslot of a superframe. A request and a response for relay communication can be performed in one superframe or in more than one superframe. If a request and a response for relay communication are performed in one superframe, the request and the response are performed in a time division defined by one superframe. In the present embodiment, an information element of the beacon #m is used for a request and a response for relay communication. When information is exchanged using the beacon #m, a MAC frame forming a MAC layer includes a MAC header and a MAC frame body.

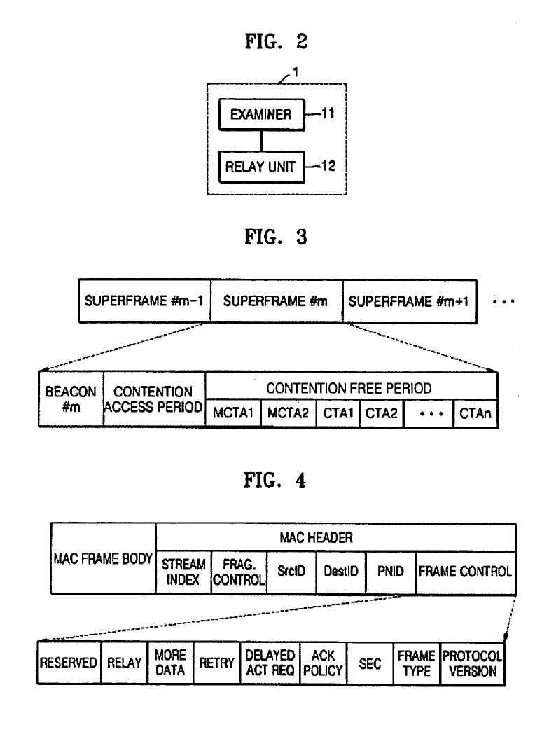

FIG. 4 illustrates a format of a MAC frame in which a request and a response for relay communication are included according to an exemplary embodiment of the present invention.

Referring to FIG. 4, a MAC frame includes a MAC header and a MAC frame body. The MAC header includes various information for a MAC layer, and the MAC frame body includes real data. The real data refers to information or data such as a command, isochronous data, and asynchronous data, that the devices 1 and 100 transmit through the piconet. Examples of the isochronous data and the asynchronous data include audio/video (AV) data, video data, audio data, phonetic data, text data, and graphic data.

A request and a response for relay communication are included in a reserved field of the MAC header. The field including the request and the response for relay communication is represented as a relay field. The names and functions of the other fields of the MAC header are fully described in the IEEE standard 802.15.3 and, thus, a detailed description is omitted here.

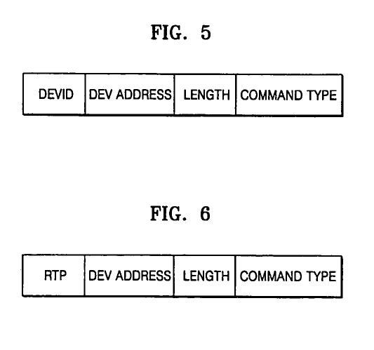

FIG. 5 illustrates a command format for requesting relay communication according to an exemplary embodiment of the present invention.

Referring to FIG. 5, a relay request is transmitted from a device 100 to the piconet coordinator 1 and includes a device identifier (DEVID), a device address (DEV address), data length (Length), and a command type. The DEVID indicates an identifier of the device 100 requesting relay communications. The DEV address indicates an address of the device 100 requesting data communication. The Length indicates entire length of command format. The command type represents whether the command is a relay request command.

FIG. 6 illustrates a command format for responding to relay communication according to an exemplary embodiment of the present invention.

Referring to FIG. 6, a relay response is transmitted from the piconet coordinator 1 to the device 100 requesting relay communication and includes a relay timeout period (RTP), a device address (DEV address), data length (Length), and a command type. The RTP indicates a period when relay communication is performed.

The DEV address indicates an address of the piconet coordinator 1. The Length indicates entire length of command format. The command type represents that the command is a relay response command. The relay response command can be represented as a relay acknowledgement or a relay reject.

With reference to configurations described above, a method of communicating through a WLAN according to an exemplary embodiment of the present invention will now be described.

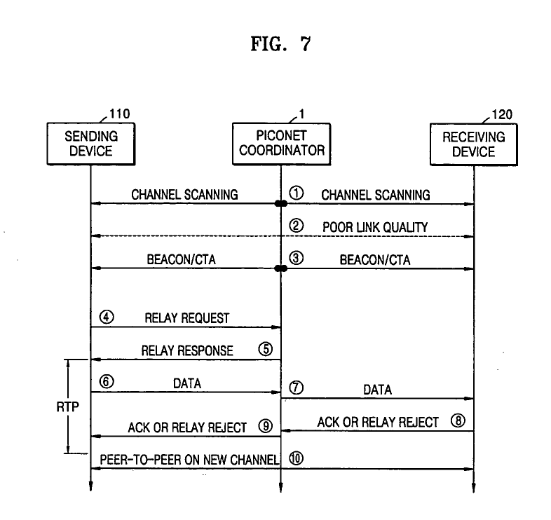

FIG. 7 illustrates a communication method according to an exemplary embodiment of the present invention.

Referring to FIG. 7, while peer-to-peer communication is performed between a sending device 110 and a receiving device 120, which are included in a piconet, the piconet coordinator 1 examines channel quality by scanning the channel in step 1. Examination of channel quality can be performed in various ways. For example, the examination can be performed by measuring an amount of data transmitted per hour or examining an occurrence of errors. A standard is appropriately determined according to contents of a performed service or a transmission speed required by the devices 110 and 120. As a result of the examination, if it is determined that the channel quality is below a predetermined standard in step 2, the piconet coordinator 1 informs the devices 110 and 120 that QoS is not guaranteed using a beacon or a CTA of timeslots forming a superframe in step 3. The piconet coordinator 1 can also inform the devices 110 and 120 that the channel quality is poor using another available timeslot of the superframe.

When the sending device 110 is informed that the channel quality is poor, the sending device 110 requests relay communication to the piconet coordinator 1 in step 4. When the relay communication is requested, if there is an available timeslot in the channel, the piconet coordinator 1 accepts a relay between the sending device 110 and the receiving device 120 in step 5. At this time, it is possible that the piconet coordinator 1, even if there is an available timeslot in the channel, determines whether the QoS is guaranteed when the available timeslot is used and accepts the relay communication only if the QoS is guaranteed. Because the relay communication is also performed using the current channel, if the QoS becomes worse by performing the relay communication, the peer-to-peer communication is more efficiently performed without changing a communication path until moving to a new channel. If the piconet coordinator 1 determines that the relay communication is preferable, the piconet coordinator 1 transmits a response of relay acceptance to the sending device 110 in step 5. In steps 4 and 5, the relay request command and the relay response command are transmitted to each other using signals with the structures shown in FIGS. 5 and 6.

If the relay request is accepted, the sending device 110 transmits data to the piconet coordinator 1 in step 6, and the piconet coordinator 1 transmits the data to the receiving device 120 in step 7. Accordingly the relay communication is performed.

If the receiving device 120 is satisfied with the data, the receiving device 120 transmits an acknowledgement (ACK) to the piconet coordinator 1 in step 8, and the piconet coordinator 1 transmits the ACK to the sending device 110 in step 9. If the receiving device 120 is not satisfied with the data (for example, if a transmission speed per hour is slower than a predetermined rate or if an error rate is higher than a predetermined rate), the receiving device 120 rejects the relay communication by sending a reject signal to the piconet coordinator 1 in step 8, and the piconet coordinator 1 relays the reject signal to the sending device 110 in step 9. Accordingly, the relay communication is terminated. Also, if an RTP passes, the relay communication is terminated. In step 7, if MAC frames are received from the sending device 110, the piconet coordinator 1 sets a relay field of a frame control field of a MAC header as shown in FIG. 4 and transmits the MAC frames to the receiving device 120 using a predetermined timeslot forming a superframe. Therefore, the relay communication is performed during the set RTP. Since the piconet coordinator 1 calculates a time required for moving to a new channel and informs the sending device 110 of the time by setting an RTP field of a relay response as shown in FIG. 6, the sending device 110 knows the RTP in advance. After the RTP passes, the piconet operates in the new channel (because the time required for moving to the new channel is calculated and set), and the sending device 110 and the receiving device 120 perform the peer-to-peer communication again in step 10.

Also, if an existing channel must be used because the piconet coordinator 1 cannot find a new channel, the relay communication can be performed until an appropriate channel is found.

As described above, according to the present invention, when channel quality is poor, higher QoS can be guaranteed until moving to a new channel. If data to be transmitted is AV data or video data, the data is very sensitive to transmission delay. Therefore, according to the present invention, when the AV data or the video data is transmitted, distortion in picture data generated due to poor channel quality can be reduced.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of communicating through a wireless network, the method comprising:
(a) examining quality of service (QoS) of a current channel; and
(b) if it is determined that the QoS of the current channel is below a predetermined standard, receiving data from a device connected to the wireless network and transmitting the data to another device connected to the wireless network.

2. The method of claim 1, wherein step (b) is performed during a predetermined time required for moving to another channel other than the current channel.

3. The method of claim 1, wherein step (b) comprises:
(b1) informing devices connected to the wireless network that the QoS of the current channel is below the predetermined standard;
(b2) receiving a relay request from a sending device;
(b3) transmitting a relay response to the sending device in response to the relay request; and
(b4) receiving data from the sending device and transmitting the data to a receiving device.

4. The method of claim 1, wherein, in step (b), the data is received or transmitted using a timeslot obtained by time-sharing a channel linking the wireless network.

5. A method of communicating through a wireless network, the method comprising:
(a) examining quality of service (QoS) of a current channel;
(b) if it is determined that the QoS of the current channel is below a predetermined standard as a result of the examination, transmitting a beacon including information indicating that the QoS of the current channel is below the predetermined standard to devices connected to the wireless network;
(c) receiving a relay request included in the beacon from a sending device;
(d) transmitting the beacon including a relay response to the sending device in response to the relay request; and
(e) receiving data from the sending device and transmitting the data to a receiving device.

6. The method of claim 5, wherein steps (b) through (e) are performed using a timeslot obtained by time-sharing the current channel.

7. The method of claim 5, wherein steps (c) and (d) are performed using a medium access control (MAC) header of the beacon.

8. The method of claim 5, wherein steps (c) and (d) are performed using at least one superframe obtained by time-sharing the current channel.

9. The method of claim 5, wherein steps (c) and (d) are performed using a timeslot of a superframe obtained by time-sharing the current channel.

10. The method of claim 5, wherein step (e) is repeated until a predetermined time elapses.

11. An apparatus connected to a wireless network, the apparatus comprising:
an examiner, operable to examine quality of service (QoS) of a current channel; and
a relay unit, which, if it is determined that the QoS of the current channel is below a predetermined standard as a result of the examination by the examiner, receives data from a sending device connected to the wireless network and transmits the received data to a receiving device also connected to the wireless network.

12. The apparatus of claim 11, wherein the relay unit is operable to receive data from the sending device and transmit the data to the receiving device during a predetermined time required for moving to another channel other than the current channel.

13. The apparatus of claim 11, wherein the relay unit is operable to inform devices connected to the wireless network when the QoS of the current channel is below the predetermined standard, receive a relay request from the sending device, transmit a relay response to the sending device in response to the relay request, receive data from the sending device, and transmit the data to the receiving device.

14. The apparatus of claim 11, wherein the relay unit receives or transmits the data using a timeslot obtained by time-sharing a channel linking the wireless network.

15. An apparatus connected to a wireless network, the apparatus comprising:
an examiner operable to examine quality of service (QoS) of a current channel; and
a relay unit, which, if it is determined that the QoS of the current channel is below a predetermined standard as a result of the examination by the examiner, transmits a beacon including information indicating that the QoS of the current channel is below the predetermined standard to devices connected to the wireless network, receives a relay request included in the beacon from a sending device, transmits the beacon including a relay response to the sending device in response to the relay request, receives data from the sending device, and transmits the data to a receiving device.

16. The apparatus of claim 15, wherein the relay unit performs at least one of receiving and transmitting the data using a timeslot obtained by time-sharing a channel linking the wireless network.

17. The apparatus of claim 15, wherein the relay unit is operable to transmit the beacon with a medium access control (MAC) header including the relay request and the relay response.

18. The apparatus of claim 15, wherein the relay unit is operable to communicate with the device using at least one superframe obtained by time-sharing the current channel.

19. The apparatus of claim 15, wherein the relay unit is operable to communicate with the device using a timeslot of a superframe obtained by time-sharing the current channel.
